(19) United States
(12) Patent Application Publication
(10) Pub. No.: US 2016/0101681 A1
(43) Pub. Date: Apr. 14, 2016

(54) HYBRID-VEHICLE DRIVING DEVICE

(71) Applicant: TOYOTA JIDOSHA KABUSHIKI KAISHA, Aichi (JP)

(72) Inventors: Shigeru OKUWAKI, Gotemba-shi, Shizuoka-ken (JP); Kenji ITAGAKI, Sunto-gun, Shizuoka-ken (JP); Hidehumi AIKAWA, Sunto-gun, Shizuoka-ken (JP); Youmei HAKUMURA, Susono-shi, Shizuoka-ken (JP)

(73) Assignee: TOYOTA JIDOSHA KABUSHIKI KAISHA, Toyota-shi, Aichi-ken (JP)

(21) Appl. No.: 14/890,792

(22) PCT Filed: May 13, 2013
(86) PCT No.: PCT/JP2013/063320

§ 371 Date: Nov. 12, 2015

(51) Int. Cl. B60K 6/445; B60K 6/387; B60K 6/365

(52) U.S. Cl. CPC B60K 6/445; B60K 6/365; B60K 6/387; F16H 2037/0866

(57) ABSTRACT

A driving device includes: a power distribution mechanism configured such that a ring gear is connected to an internal combustion engine, a sun gear is connected to a first MG, and a carrier is connected to a counter shaft in a power transmittable manner; and a clutch mechanism that is able to connect the sun gear to the ring gear. The internal combustion engine, the first MG, the power distribution mechanism, and the clutch mechanism are placed on the same axis. The clutch mechanism is placed on an opposite side to the internal combustion engine across the first MG and the power distribution mechanism.

### TECHNICAL FIELD

The present invention relates to a driving device for a hybrid vehicle, which includes a power distribution mechanism that is able to divide an output of an internal combustion engine to a motor generator and an output member.

### BACKGROUND ART

There has been known a driving device for a hybrid vehicle, which includes a single-pinion planet gear mechanism as a power distribution mechanism and which is configured such that an internal combustion engine is connected to a ring gear of the planet gear mechanism, a motor generator is connected to a sun gear, and an input shaft of a transmission is connected to a carrier. Further, as such a driving device, there has been known a device that can output an output of an internal combustion engine to a transmission without any change, by connecting a sun gear to a ring gear via a clutch mechanism (see Patent Document 1). Further, there are Patent Documents 2, 3 as prior art documents associated with the present invention.

### CITATION LIST

### Patent Documents

Patent Document 1: Japanese Patent Application Publication No. 09-158997 (JP 09-158997 A)

Patent Document 2: Japanese Patent Application Publication No. 2001-224104 (JP 2001-224104 A)

Patent Document 3: International Publication No. 2012/131218

### SUMMARY OF THE INVENTION

### Problem to be Solved by the Invention

In the device of Patent Document 1, in order to connect the power distribution mechanism to the transmission, an output shaft of the internal combustion engine and an input shaft of the transmission are placed on the same axis. On that account, a clutch for connecting the sun gear to the ring gear is placed between the motor generator and the planet gear mechanism. In this case, it is necessary for the clutch to have the same outside diameter as the ring gear, which might upsize the device.

In view of this, an object of the present invention is to provide a driving device for a hybrid vehicle, which is able to downsize a clutch mechanism and to improve mountability to a vehicle.

### Means for Solving the Problem

A first driving device of the present invention includes: an internal combustion engine; a first motor generator; an output member connected to a drive wheel in a power transmittable manner; a power distribution mechanism including a first rotating element, a second rotating element, and a third rotating element that are mutually rotatable in a differential manner, the third rotating element being placed between the first rotating element and the second rotating element on a collinear diagram, the first rotating element being connected to the internal combustion engine, the second rotating element being connected to the first motor generator, the third rotating element being connected to the output member in a power transmittable manner; a second motor generator that is able to output power to the output member; and a clutch mechanism that is able to switch an engaged state in which the first rotating element is connected to the second rotating element and a disengaged state in which the first rotating element is disconnected from the second rotating element, wherein the internal combustion engine, the first motor generator, the power distribution mechanism, and the clutch mechanism are placed on the same axis, and the clutch mechanism is placed on an opposite side to the internal combustion engine across the first motor generator and the power distribution mechanism.

In the first driving device of the present invention, the clutch mechanism is placed on an opposite side to the internal combustion engine across the first motor generator and the power distribution mechanism. That is, the clutch mechanism is placed on an endmost of the axis. This allows the clutch mechanism to have a small outside diameter. Hereby, the clutch mechanism can be downsized, thereby making it possible to downsize the driving device. Accordingly, it is possible to improve mountability to a vehicle.

A second driving device of the present invention includes: an internal combustion engine; a first motor generator; an output member connected to a drive wheel in a power transmittable manner; a power distribution mechanism including a first rotating element, a second rotating element, and a third rotating element that are mutually rotatable in a differential manner, the third rotating element being placed between the first rotating element and the second rotating element on a collinear diagram, the first rotating element being connected to the internal combustion engine, the second rotating element being connected to the first motor generator, and the third rotating element being connected to the output member in a power transmittable manner; a second motor generator that is able to output power to the output member; and a clutch mechanism that is able to switch an engaged state in which the first rotating element is connected to the second rotating element and a disengaged state in which the first rotating element is disconnected from the second rotating element, wherein the internal combustion engine, the first motor generator, the power distribution mechanism, and the clutch mechanism are placed on the same axis, the power distribution mechanism is placed between the internal combustion engine and the first motor generator, and the clutch mechanism is placed between the internal combustion engine and the power distribution mechanism.

In the second driving device of the present invention, the clutch mechanism is placed between the internal combustion engine and the power distribution mechanism. In this case, since the clutch mechanism can be provided in a member that connects the internal combustion engine to the first rotating element, it is not necessary for an outside diameter of the clutch mechanism to be made as large as an outside diameter of the first rotating element. This allows the clutch mechanism to have a small outside diameter. Accordingly, the driving device can be downsized, thereby making it possible to improve mountability to a vehicle.

In one aspect of the first or second driving device of the present invention, the second motor generator may be placed on an axis different from the axis on which the clutch mechanism is placed. Further, the output member may be placed on an axis different from the axis on which the clutch mechanism is placed. Thus, since the second motor generator or the output member is placed on an axis different from the axis on which the clutch mechanism is placed, it is possible to shorten a length of the driving device along an axis direction. This makes it possible to further downsize the driving device. Moreover, it is possible to further improve the mountability to the vehicle.

### BRIEF DESCRIPTION OF THE DRAWINGS

FIG. 1 is a view schematically illustrating a driving device according to a first embodiment of the present invention.

FIG. 2 is a view illustrating an example of a collinear diagram of the driving device.

FIG. 3 is a view schematically illustrating a part of a driving device in which a clutch mechanism is provided between a sun gear and a carrier.

FIG. 4 is a view schematically illustrating a part of a driving device in which a clutch mechanism is provided between a carrier and a ring gear.

FIG. 5 is a view schematically illustrating a driving device according to a second embodiment of the present invention.

FIG. 6 is a view schematically illustrating a driving device according to a third embodiment of the present invention.

### MODES FOR CARRYING OUT THE INVENTION

### First Embodiment

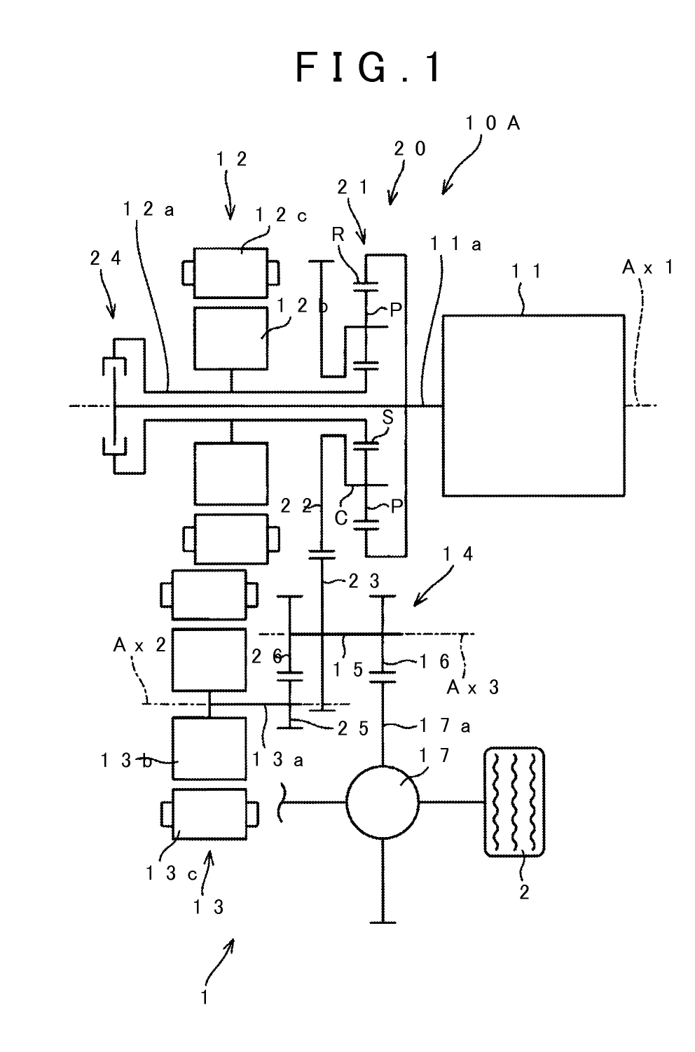

FIG. 1 is a skeleton diagram of a driving device according to the first embodiment of the present invention. A driving device 10A is provided in a hybrid vehicle 1, and includes an internal combustion engine (hereinafter also referred to as an engine) 11, a first motor generator (hereinafter referred to as a first MG) 12, and a second motor generator (hereinafter referred to as a second MG) 13. The engine 11 is a well-known spark-ignition internal combustion engine to be provided in a hybrid vehicle. Therefore, detailed descriptions thereof are omitted herein.

The first MG 12 and the second MG 13 are a well-known motor generator functioning as a generator and as a motor. The first MG 12 includes a rotor 12b rotating integrally with a rotor shaft 12a, and a stator 12c placed coaxially on an outer periphery of the rotor 12b and fixed to a case (not shown). Similarly, the second MG 13 includes a rotor 13b rotating integrally with a rotor shaft 13a, and a stator 13c placed coaxially on an outer periphery of the rotor 13b and fixed to the case.

An output shaft 11a of the engine 11 and the rotor shaft 12a of the first MG 12 are connected to the power distribution mechanism 20. An output portion 14 for outputting power to driving wheels 2 of a vehicle 1 is also connected to the power distribution mechanism 20. The output portion 14 includes a counter shaft 15 as an output member, and an output gear 16 rotating integrally with the counter shaft 15. The output gear 16 meshes with a ring gear 17a provided in a case of a differential mechanism 17. The differential mechanism 17 is a well-known mechanism for distributing power transmitted to the ring gear 17a between right and left driving wheels 2.

The power distribution mechanism 20 includes a single-pinion planet gear mechanism 21. The planet gear mechanism 21 includes: a sun gear S, which is an external gear; a ring gear R, which is an internal gear placed coaxially to the sun gear S; and a carrier C for holding pinion gears P meshing with the gears S, R so that the pinion gears P can spin and revolve around the sun gear S. As illustrated in the figure, the sun gear S is connected to the rotor shaft 12a of the first MG 12 so as to rotate integrally therewith. The ring gear R is connected to the output shaft 11a of the engine 11 so as to rotate integrally therewith. The carrier C is connected to a first drive gear 22 so as to rotate integrally therewith. The first drive gear 22 meshes with a first driven gear 23 provided in the counter shaft 15.

As illustrated in the figure, the sun gear S is connected to the ring gear R via the clutch mechanism 24. The clutch mechanism 24 can switch between an engaged state in which the sun gear S is connected to the ring gear R and a disengaged state in which the sun gear S is disconnected from the ring gear R. A well-known friction clutch is used as the clutch mechanism 24.

As illustrated in the figure, the engine 11, the power distribution mechanism 20, the first MG 12, and the clutch mechanism 24 are placed on the same axis Ax1. The power distribution mechanism 20 is placed between the engine 11 and the first MG 12. The clutch mechanism 24 is placed on a side opposite to the engine 11 across the power distribution mechanism 20 and the first MG 12. Accordingly, as illustrated in the figure, the clutch mechanism 24 is placed on an endmost of the axis Ax1.

The rotor shaft 13a of the second MG 13 is provided with a second drive gear 25. The second drive gear 25 meshes with a second driven gear 26 provided in the counter shaft 15. As illustrated in the figure, the second MG 13 is placed on an axis Ax2 different from the axis Ax1 on which the clutch mechanism 24 is placed. Further, the counter shaft 15 is placed on an axis Ax3 different from the axis Axa and the axis Ax2.

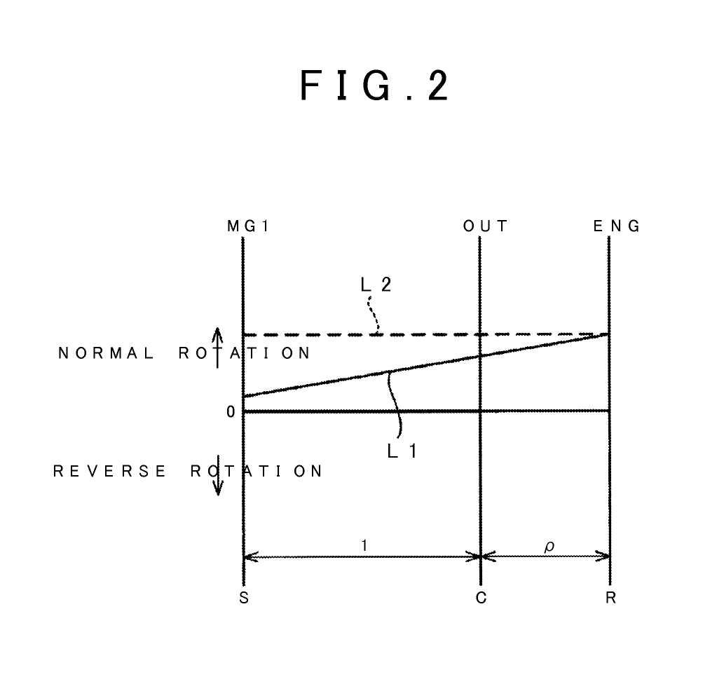

FIG. 2 illustrates an example of a collinear diagram of the driving device 10A. Note that “ENG” in the figure indicates the engine 11. “OUT” indicates the first drive gear 22. “MG1” indicates the first MG 12. “S” indicates the sun gear S, “R” indicates the ring gear R, and “C” indicates the carrier C. “p” indicates a change gear ratio between the carrier C and the ring gear R. When a change gear ratio between the sun gear S and the carrier C is assumed “1,” the change gear ratio ρ is set to a value smaller than 1. The change gear ratio ρ is also called a planetary ratio.

A continuous line L1 in the figure indicates a relationship among those rotating elements at the time when the clutch mechanism 24 is in a disengaged state. In this case, the sun gear S, the ring gear R, and the carrier C can rotate separately. Accordingly, when a rotation number of the first MG 12 is changed, it is possible to continuously change a ratio between a rotation number of the engine 11 and a rotation number of the first drive gear 22.

A broken line L2 in the figure indicates a relationship among the rotating elements at the time when the clutch mechanism 24 is in an engaged state. When the sun gear S is connected to the ring gear R, the sun gear S, the ring gear R, and the carrier C rotate integrally. Accordingly, the ratio between the rotation number of the engine 11 and the rotation number of the first drive gear 22 is fixed to 1.

Formula (1) as follows indicates a torque sharing ratio of the clutch mechanism 24 at the time when the clutch mechanism 24 is in an engaged state. Note that “Te” in this formula indicates a torque of the engine 11, and “Tmg” indicates a torque of the first MG 12. Further, “ρ” indicates a planetary ratio as described above.

$$\begin{matrix}[ Math 1 ] & \\ \vert \frac{1}{1 + ρ} ( ρ Te - Tmg ) \vert & ( 1 )\end{matrix}$$

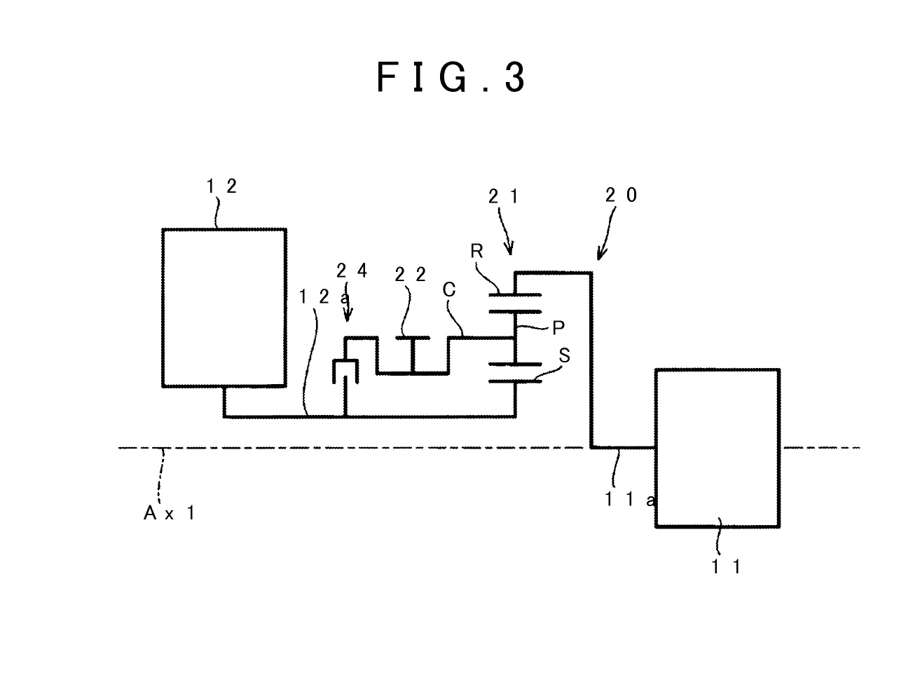

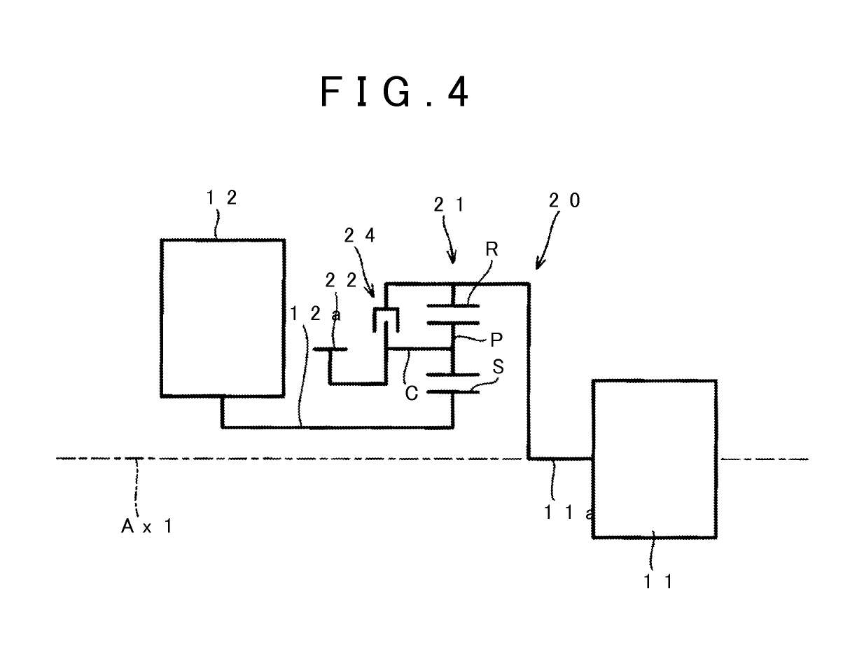

As a comparative example, a torque sharing ratio at the time when the clutch mechanism 24 is provided between the sun gear S and the carrier C as illustrated in FIG. 3 is expressed by Formula (2). Similarly, as a comparative example, a torque sharing ratio at the time when the clutch mechanism 24 is provided between the carrier C and the ring gear R as illustrated in FIG. 4 is expressed as Formula (3). Note that, in FIGS. 3, 4, the same reference sign is assigned to a portion common to FIG. 1, and a description thereof is omitted.

$$\begin{matrix}[ Math 2 ] & \\ \vert ( ρ Te - Tmg ) \vert & ( 2 ) \\ \vert \frac{1}{ρ} ( ρ Te - Tmg ) \vert & ( 3 )\end{matrix}$$

As apparent from these formulae, the torque sharing ratio is smallest in a case where the clutch mechanism 24 is provided between the sun gear S and the ring gear R.

As described above, in the driving device 10A according to the first embodiment, since the clutch mechanism 24 is placed on a side opposite to the engine 11 across the power distribution mechanism 20 and the first MG 12, the outside diameter of the clutch mechanism 24 can be made small. This allows the clutch mechanism 24 to be downsized, thereby making it possible to downsize the driving device 10A. This accordingly makes it possible to improve mountability to the vehicle 1.

Further, in the driving device 10A, the second MG 13 is placed on the axis Ax2, and the counter shaft 15 is placed on the axis Ax3. As such, since the second MG 13 and the counter shaft 15 are placed on respective axes different from the axis Ax1 on which the clutch mechanism 24 is placed, it is possible to shorten a length of the driving device 10A along an axis direction. This accordingly makes it possible to further improve the mountability to the vehicle 1.

Note that, in this embodiment, the ring gear R corresponds to a first rotating element of the present invention. The sun gear S corresponds to a second rotating element of the present invention. The carrier C corresponds to a third rotating element of the present invention.

### Second Embodiment

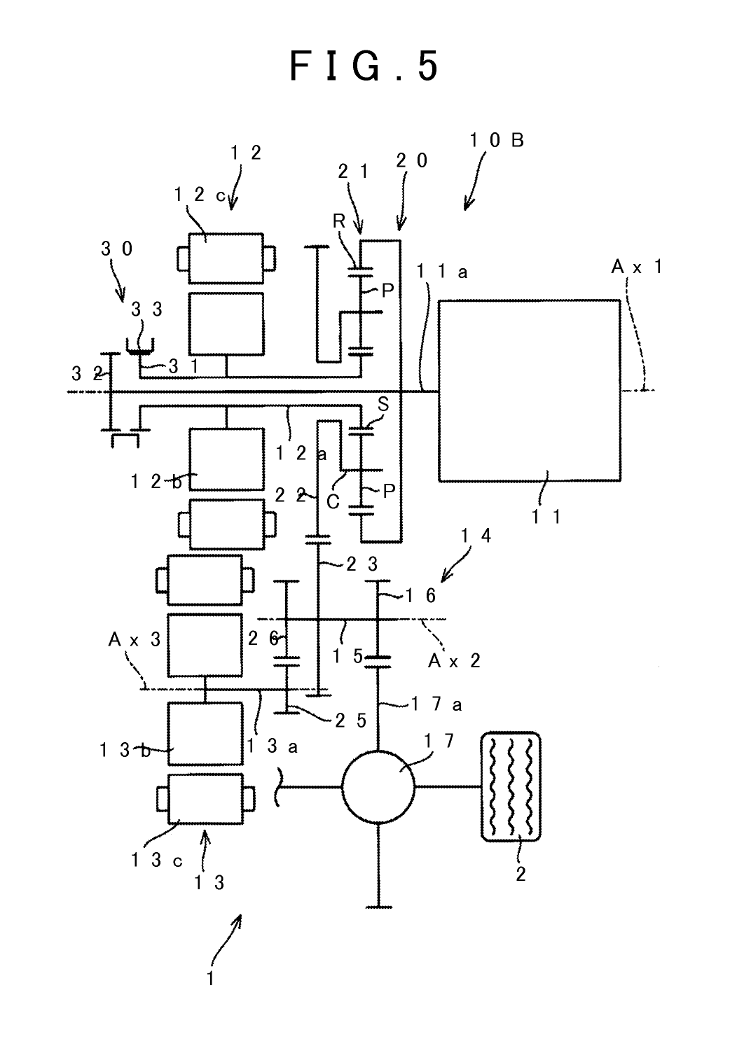

FIG. 5 schematically illustrates a driving device 10B according to a second embodiment of the present invention. Note that, in this figure, the same reference sign is assigned to a portion common to FIG. 1, and a description thereof is omitted. In this embodiment, a dog clutch mechanism 30 is provided instead of the clutch mechanism 24. The other configuration is the same as in the first embodiment.

The dog clutch mechanism 30 includes a first engaging member 31 configured to rotate integrally with a sun gear S, and a second engaging member 32 configured to rotate integrally with a ring gear R. A sleeve 33 is provided on outer peripheries of these engaging members 31, 32. The sleeve 33 is supported by the first engaging member 31 so that the sleeve 33 is movable in a direction of an axis Ax1. Further, the sleeve 33 is provided so as to be movable between a disengaged position at which the sleeve 33 engages with only the first engaging member 31 and an engaged position at which the sleeve 33 engages with both the first engaging member 31 and the second engaging member 32. Note that, in this figure, an upper side relative to the axis Ax1 indicates a state where the sleeve 33 is placed at the disengaged position, and a lower side relative to the axis Ax1 indicates a state where the sleeve 33 is placed at the engaged position.

As illustrated in this figure, similarly to the clutch mechanism 24 in the first embodiment, the dog clutch mechanism 30 is also placed on a side opposite to an engine 11 across a power distribution mechanism 20 and a first MG 12. Accordingly, as illustrated in the figure, the dog clutch mechanism 30 is placed on an endmost of the axis Ax1.

In the driving device 10B, the sun gear S can be connected to the ring gear R by moving the sleeve 33 to the engaged position. In the meantime, the sun gear S can be disconnected from the ring gear R by moving the sleeve 33 to the disengaged position. On that account, FIG. 2 is referred to in terms of a collinear diagram in this embodiment.

As described above, in the driving device 10B of this embodiment, the dog clutch mechanism 30 is also placed on a side opposite to the engine 11 across the power distribution mechanism 20 and the first MG 12. This allows the clutch mechanism 24 to be downsized. Further, also in this embodiment, a second MG 13 and a counter shaft 15 are placed on respective axes different from the axis Ax1 on which the clutch mechanism 24 is placed. Accordingly, it is possible to shorten a length of the driving device 10B along an axis direction. This makes it possible to downsize the driving device 10B. Further, it is possible to improve mountability to a vehicle 1.

### Third Embodiment

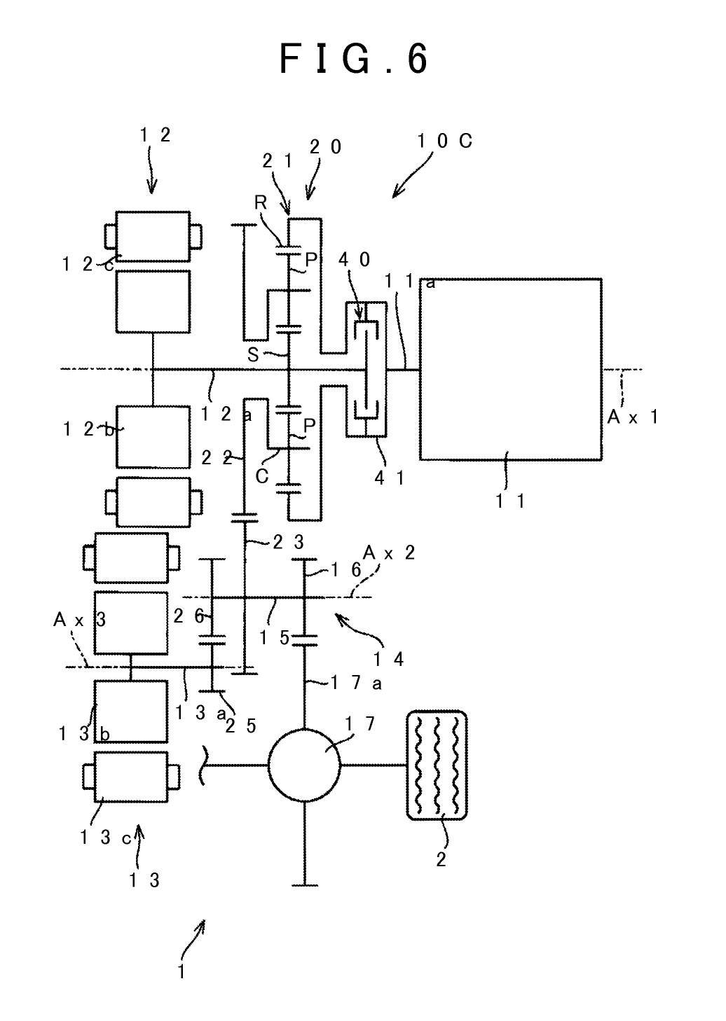

FIG. 6 schematically illustrates a driving device 10C according to a third embodiment of the present invention. Note that, in FIG. 6, the same reference sign is assigned to a portion common to FIG. 1, and a description thereof is omitted. In this embodiment, a clutch mechanism 40 is provided instead of the clutch mechanism 24, which is a different point. The other configuration is the same as in the first embodiment.

As illustrated in this figure, the clutch mechanism 40 is placed between an engine 11 and a power distribution mechanism 20. A well-known friction clutch is used as the clutch mechanism 40. As illustrated in the figure, an output shaft 11a of the engine 11 is connected to a ring gear R via a connection member 41. Further, as illustrated in this figure, an output shaft 12a of a first MG 12 is extended to between the power distribution mechanism 20 and the engine 11. The clutch mechanism 40 is provided between the connection member 41 and the output shaft 12a.

The clutch mechanism 40 can switch between an engaged state in which the connection member 41 is connected to the output shaft 12a and a disengaged state in which the connection member 41 is disconnected from the output shaft 12a. The connection member 41 is connected to the ring gear R. The output shaft 12a is connected to the sun gear S. On that account, when the clutch mechanism 40 is switched to the engaged state, the sun gear S is connected to the ring gear R. In the meantime, when the clutch mechanism 40 is switched to the disengaged state, the sun gear S is disconnected from the ring gear R. On that account, FIG. 2 is also referred to in terms of a collinear diagram in this embodiment.

In the driving device 10C according to the third embodiment, since the clutch mechanism 40 is placed between the engine 11 and the power distribution mechanism 20, it is not necessary for an outside diameter of the clutch mechanism 40 to be made as large as an outside diameter of the ring gear R, as illustrated in FIG. 6. This allows the clutch mechanism 40 to have a small outside diameter. Further, also in this embodiment, a second MG 13 and a counter shaft 15 are placed on respective axes different from an axis Ax1 on which the clutch mechanism 24 is placed. Accordingly, it is possible to shorten a length of the driving device 10C along an axis direction. This makes it possible to downsize the driving device 10C. Further, it is possible to improve mountability to a vehicle 1.

The present invention is not limited to the above embodiments, and can be performed in various embodiments. For example, the planet gear mechanism provided in the driving device of the present invention is not limited to a single-pinion planet gear mechanism. In the driving device of the present invention, a double-pinion planet gear mechanism may be used. However, in this case, connection destinations of the ring gear and the carrier in each embodiment are changed appropriately.

What is claimed is:

1. A driving device for a hybrid vehicle, comprising:
an internal combustion engine;
a first motor generator;
an output member connected to a drive wheel in a power transmittable manner;
a power distribution mechanism including a first rotating element, a second rotating element, and a third rotating element that are mutually rotatable in a differential manner, the third rotating element being placed between the first rotating element and the second rotating element on a collinear diagram, the first rotating element being connected to the internal combustion engine, the second rotating element being connected to the first motor generator, and the third rotating element being connected to the output member in a power transmittable manner;
a second motor generator that is able to output power to the output member; and
a clutch mechanism that is able to switch between an engaged state and a disengaged state, the engaged state being a state in which the first rotating element is connected to the second rotating element, and the disengaged state being a state in which the first rotating element is disconnected from the second rotating element, wherein
the internal combustion engine, the first motor generator, the power distribution mechanism, and the clutch mechanism are placed on the same axis, and
the first motor generator and the power distribution mechanism are place between the clutch mechanism and the internal combustion engine.

2. A driving device for a hybrid vehicle, comprising:
an internal combustion engine;
a first motor generator;
an output member connected to a drive wheel in a power transmittable manner;
a power distribution mechanism including a first rotating element, a second rotating element, and a third rotating element that are mutually rotatable in a differential manner, the third rotating element being placed between the first rotating element and the second rotating element on a collinear diagram, the first rotating element being connected to the internal combustion engine, the second rotating element being connected to the first motor generator, and the third rotating element being connected to the output member in a power transmittable manner;
a second motor generator that is able to output power to the output member; and
a clutch mechanism that is able to switch between an engaged state and a disengaged state, the engaged state being a state in which the first rotating element is connected to the second rotating element, and the disengaged state being a state in which the first rotating element is disconnected from the second rotating element, wherein
the internal combustion engine, the first motor generator, the power distribution mechanism, and the clutch mechanism are placed on the same axis,
the power distribution mechanism is placed between the internal combustion engine and the first motor generator, and
the clutch mechanism is placed between the internal combustion engine and the power distribution mechanism.

3. The driving device according to claim 1, wherein
the second motor generator is placed on an axis different from the axis on which the clutch mechanism is placed.

4. The driving device according to claim 1, wherein
the output member is placed on an axis different from the axis on which the clutch mechanism is placed.

5. The driving device according to claim 2, wherein
the second motor generator is placed on an axis different from the axis on which the clutch mechanism is placed.

6. The driving device according to claim 2, wherein
the output member is placed on an axis different from the axis on which the clutch mechanism is placed.
